(19) United States
(12) Patent Application Publication
(10) Pub. No.: US 2023/0183532 A1
(43) Pub. Date: Jun. 15, 2023

(54) WATERBORNE TWO-PART ADHESIVES AND USE THEREOF

(71) Applicant: HENKEL AG & CO., KGAA, Duesseldorf (DE)

(72) Inventors: Tianjian HUANG, Hillsborough, NJ (US); Kristina THOMPSON, Clinton, NJ (US); Steven KERN, Nokomis, FL (US)

(21) Appl. No.: 18/164,684

(22) Filed: Feb. 6, 2023

Related U.S. Application Data
(63) Continuation of application No. PCT/US21/45478, filed on Aug. 11, 2021.
(60) Provisional application No. 63/064,127, filed on Aug. 11, 2020.

(51) Int. Cl. C09J 131/04; B32B 7/12; B32B 29/00; B32B 21/02; B32B 21/06; B32B 21/04; B32B 27/10; B32B 21/08; B32B 27/08; B32B 3/28

(52) U.S. Cl. CPC C09J 131/04; B32B 7/12; B32B 29/005; B32B 21/02; B32B 21/06; B32B 21/042; B32B 27/10; B32B 21/08; B32B 27/08; B32B 3/28; B32B 2255/08; B32B 2255/12; B32B 2255/10; B32B 2255/26

(57) ABSTRACT

A waterborne, two-part adhesive composition having improved wet tack properties is disclosed. The two-part adhesive composition is particularly suitable for making laminates, including paperboard products.

### FIELD OF THE INVENTION

The present invention relates to a two-part adhesive composition having improved wet tack properties. In particular, the invention includes an adhesive composition and method of making laminates, including paperboard products.

### BACKGROUND OF THE INVENTION

Paper board, including corrugated paper board, is commonly used in packaging goods for transport and/or storage. Traditionally, corrugated paper board is prepared by first forming a corrugated element, or “medium”, by passing a cellulosic sheet between corrugating rolls forming a substantially sinusoidal or serpentine cross-section in the sheet. The tips of the sinusoidal portion are referred to as flutes. An adhesive is commonly applied to the tips of the flutes, and a noncorrugated or planar cellulosic liner is applied against the adhesive coated flutes of the corrugated elements as the corrugated sheet passes between a corrugating roll and a pressure roll or belt. A resulting paper product having the corrugating medium on one side and the planar liner on another side is called a single-faced web. The single-faced element may be used as is in certain applications as a liner or buffer material within a container. In some products, the adhesive is also applied to the flute tips of the single-faced web and a second liner sheet is subsequently applied to the fluted medium in a “double faced” operation. The second liner sheet is exposed to conditions of heat and pressure during its contact with the adhesive. In practice, the sheet of corrugated cardboard most frequently encountered has two plane sides placed on each side of the corrugated medium. Depending on the specific strength desired, a sheet of corrugated board may also be provided with a more complex structure, such as two corrugated mediums and three plane surfaces, two outer ones and one inner one separating the two corrugated mediums.

Starch-based adhesives are commonly used in the corrugating process due to their desirable adhesive properties, low cost, and ease of preparation. The most fundamental starch corrugating adhesive, commonly referred to as a “Stein-Hall” formulation, is an alkaline adhesive made from raw, ungelatinized starch suspended in an aqueous dispersion of cooked starch. The adhesive is produced by gelatinizing starch in water with sodium hydroxide (caustic soda) to yield a primary mix of gelatinized or cooked carrier, which is then slowly added to a secondary mix of raw (ungelatinized) starch, borax and water to produce the fully formulated adhesive. In conventional corrugating processes, the adhesive is applied to the tips of the fluted paper medium or single-faced board, whereupon the application of high heat and pressure causes the raw starch to gelatinize, resulting in an instantaneous increase in viscosity and formation of the adhesive bond. The use of high heat and pressure allows for fast throughput since this allows for fast gelatinization. Without this heat for fast gelatinization, the throughput would be significantly decreased since its wet tack is low. However, high heat and pressure in the process utilizes significant amount of energy, and can shorten the lifetime and increase the downtime for equipment. In addition, high temperatures and pressure creates a safety hazard for equipment operators. Decreasing the amount of heat in forming the laminate would benefit the environment, equipment, and safety.

### SUMMARY OF THE INVENTION

The present invention relates to a two-part adhesive composition for cellulosic substrates that provides improved wet tack properties. The improved wet tack is developed at lower temperatures than common Stein-Hall temperatures and allows for fast throughput at lower temperatures.

In a first embodiment of the present invention, there is provided an adhesive comprising a reaction product of:
(a) a Composition A comprising polyethyleneimine (PEI) in a polyvinyl alcohol solution having a pH value greater than 9; and
(b) a Composition B comprising boric acid and polyvinyl alcohol stabilized ethylene-co-vinyl acetate emulsion polymer.

Another embodiment of the invention provides a laminate comprising:
(a) a substrate 1;
(b) a substrate 2; and
(c) an adhesive comprising the reaction product of a Composition A and a Composition B. The Composition A comprises PEI in polyvinyl alcohol solution with a pH greater than about 9; and the Composition B comprises boric acid and polyvinyl alcohol stabilized ethylene-co-vinyl acetate emulsion polymer.

Still another embodiment of the invention provides a method of making a laminate comprising the steps of:
(a) preparing a composition A comprising PEI in a polyvinyl alcohol solution with a pH greater than about 9;
(b) preparing a composition B comprising boric acid and polyvinyl alcohol stabilized ethylene-co-vinyl acetate emulsion polymer;
(c) preparing a substate 1 having a first side and a second side;
(d) preparing a substrate 2 having a first side and a second side;
(e) applying the adhesive A on the first side of the substrate 1;
(f) applying the adhesive B on the second side of the substrate 2; and
(g) mating the adhesive A on the first side of the substrate 1 to the adhesive B on the second side of the substrate 2 onto each other.

In another embodiment of the present invention, there is provided an adhesive comprising a reaction product of:
(a) a Composition C comprising polyvinyl acetate emulsion polymer stabilized by hydroxyethyl cellulose (HEC) and aminoborate compound; and
(b) a Composition D comprising polyvinyl alcohol stabilized ethylene vinyl acetate emulsion polymer and polyethyleneimine.
   The combination of composition C and composition D provides a rapid, almost immediate reaction to provide wet tack adhesion to substrates. The aminoborate compound in Composition C crosslinks polyvinyl alcohol in Composition D, while the polyvinyl acetate emulsion polymer provides high solids, and PEI provides improved water resistance.

Yet in another embodiment of the invention provides a laminate comprising
(a) a substrate 1;
(b) a substrate 2; and
(c) an adhesive comprising the reaction product of Composition C and Composition D,
   The composition C comprises polyvinyl acetate emulsion polymer stabilized by hydroxyethyl cellulose (HEC) and aminoborate compound; and Composition D comprises polyvinyl alcohol stabilized ethylene vinyl acetate emulsion polymer and polyethyleneimine.

Still another embodiment of the invention provides a method of making a laminate comprising the steps of:
(a) preparing a composition C comprising polyvinyl acetate emulsion polymer stabilized by hydroxyethyl cellulose (HEC) and aminoborate compound;
(b) preparing a Composition D comprising polyvinyl alcohol stabilized ethylene vinyl acetate emulsion polymer and polyethyleneimine;
(c) preparing a substate 1 having a first side and a second side;
(d) preparing a substrate 2 having a first side and a second side;
(e) applying the adhesive C on the first side of the substrate 1; and
(f) applying the adhesive D on the second side of the substrate 2 Mating the adhesive C on the first side of the substrate 1 to the adhesive D on the second side of the substrate 2 onto each other.

### BRIEF DESCRIPTION OF THE FIGURES

FIG. 1 is a graph of wet tack adhesion for various adhesives, including a combination of Composition A and Composition B.

FIG. 2 is a graph of wet tack adhesion for the combined Composition C and Composition D on different substrates.

### DETAILED DESCRIPTION OF THE INVENTION

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present disclosure. All publications, patent applications, patents and other references mentioned herein are incorporated by reference in their entirety. The materials, methods, and examples disclosed herein are illustrative only and not intended to be limiting.

As used herein, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

Numerical values herein, particularly as they relate to polymers or polymer compositions, reflect average values for a composition that may contain individual polymers of different characteristics. Furthermore, unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 to 10” is inclusive of the endpoints, 2 and 10, and all the intermediate values). The endpoints of the ranges and any values disclosed herein are not limited to the precise range or value; they are sufficiently imprecise to include values approximating these ranges and/or values. As used herein, approximating language may be applied to modify any quantitative representation that may vary without resulting in a change in the basic function to which it is related. Accordingly, a value modified by a term or terms, such as “about,” may not be limited to the precise value specified, in some cases. In at least some instances, the approximating language may correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11”, and “about 1” may mean from 0.9-1.1. Other meanings of “about” may be apparent from the context, such as rounding off, so, for example “about 1” may also mean from 0.5 to 1.4.

The present invention is based on the discovery that a two-part system, when combined, provides rapid and fast wet tack adhesion. As the two-part system is combined, they form, within three seconds, an adhesive that gels and crosslinks. As the water is evaporated or dissipates, the adhesive cures. This two-part system is particularly advantageous for cellulosic substrates to form laminates.

In a first embodiment, the invention includes an adhesive comprising a reaction product of:
(a) a Composition A comprising PEI in a polyvinyl alcohol solution with a pH greater than about 9; and
(b) a Composition B comprising boric acid and polyvinyl alcohol stabilized ethylene-co-vinyl acetate emulsion polymer.
   The combination of composition A and composition B provides a rapid, almost immediate, within three seconds, reaction to gelatinize the polyvinyl alcohol, providing a high wet tack. The high pH of the Composition A transforms the boric acid in Composition B into borax and gelatinizes the adhesive. This combination provides improved wet tack adhesion over an uncombined system, e.g., Composition A alone or Composition B alone.

The PEI provides the reaction trigger to gelatinizes the adhesive. Other triggers, such as sodium hydroxide or other caustic material, may be substituted in Composition A. In other embodiment, other caustics, e.g., sodium hydroxide, potassium hydroxide, magnesium hydroxide, natrium hydroxide, amines, and the like, can be substituted for PEI. PEI, however, is preferred since it is a mild caustic material, and it also provides strong hydrogen bonding, which boosts the water resistance.

The polyvinyl alcohol can either be medium hydrolyzed or fully hydrolyzed grade (80% to 100%). Biocide may be any effective preservative for the high pH system.

Composition A may further comprise a biocide.

The ethylene-co-vinyl acetate emulsion polymer typically has a Tg range from −10 to 20° C.

Composition B may further comprise a plasticizer, defoamer, and biocide. The plasticizer is diethylene glycol dibenzoate, dipropylene glycol dibenzoate, propylene glycol dibenzoate, and preferably a dibenzoate ester of glycols. The defoamer can be any effective defoamer. The biocide can be any effective preservative for low to neutral pH system.

The Composition B, by itself, is a synthetic adhesive for cellulose; however, its initial wet tack is low. When Composition A and Composition B are combined as two-part adhesive, gelation is almost immediate, and often within three seconds, the wet tack of the reaction product is greater than 50 g/inch force at 2 seconds, measured on Texture Analyzer. The wet tack of the two-part adhesive further increases over time. In fact, the wet tack of the two-part system is at least 50% greater than Composition B alone.

In another embodiment, the two-part adhesive of Composition A and Composition B is applied separately onto substrates to form a laminate. The laminate is formed with Substrate 1, Substrate 2, Composition A on Substrate 1, and Composition B on Substrate 2; and the two compositions are brought together to undergo a reaction to gelatinize the two-part adhesive. Substrate 1 and Substrate 2 are cellulose based- materials and are, independently, fiberboard, cardboard, kraft paper, fluted medium, linear medium, plastic film or foil. The Composition A and Composition B are the above described compositions.

To form the laminate with two-part adhesive of Compositions A and B:
a. composition A comprising polyethyleneimine in a polyvinyl alcohol solution where pH is greater than about 9 is prepared;
b. composition B comprising boric acid and polyvinyl alcohol stabilized ethylene-co-vinyl acetate emulsion polymer is prepared;
c. substate 1 having a first side and a second side is prepared;
d. substrate 2 having a first side and a second side is prepared;
e. composition A is applied on the first side of the Substrate 1;
f. composition B is applied on the second side of the Substrate 2; and
g. mating the composition A on the first side of the Substrate 1 to the Composition B on the second side of the Substrate 2.

The laminate may further comprise additional substrate, e.g., Substrate 3, 4, 5, and the like, and each substrate may independently be selected from the group consisting of fiberboard, cardboard, kraft paper, fluted medium, linear medium, plastic film or foil. To adhere the additional substrates, Composition A and Composition B are applied on different substrates and joined together to form a two-part adhesive to gelatinize and adhere together.

The laminates may be formed at a higher temperature than ambient, room temperature. The Stein-Hall vessel temperatures are higher than the temperatures of the substrates. The temperatures recited herein are the temperatures of the substrates. The laminates may be formed at temperatures less than 250° F. In a preferred embodiment, the mating of two-part adhesive is conducted at temperature less than 190° F. In a more preferred embodiment, the mating is conducted at temperature less than 130 ° F. The laminates may also be made at room temperature without any additional heat. In some other embodiment, the laminates are made at room temperature, and additional heat or air circulation is used to drive off the excess water to hasten setting the adhesive. Optional pressure, e.g., rolls or belt, may be applied to the laminate during the mating.

Unlike a typical Stein-Hall adhesive that requires high heat to gelatinize and to create tack, the instant two-part adhesive allows for lower heat and lower pressure to form adhesive bond. In fact, this two-part adhesive decrease carbon footprint and decreases hazardous conditions for equipment operators. Moreover, the two-part adhesive provides higher initial wet tack, and as such, the throughput speed is high for making the laminates.

Yet in another embodiment of the invention is a different type of a two-part adhesive. This adhesive is a reaction product of Composition C comprising HEC stabilized polyvinyl acetate emulsion polymer and aminoborate compound, (also known as liquid borax); and Composition D comprising polyvinyl alcohol stabilized ethylene vinyl acetate emulsion polymer and PEI. On contact of the two substrates coated with Composition C and Composition D, the liquid borax gels the polyvinyl alcohol forms a rapid bond.

The aminoborate compound may be produced by reacting boric acid with ethanolamines, which are commercially available, and are readily known to those skilled in the art (https://www.sciencedirect.com/science/article/abs/pii/0277538796000472. The polyvinyl acetate emulsion polymer typically has a Tg range from 30 to 45° C. The polyvinyl acetate emulsion polymer used in combination with liquid borax are substantially free of polyvinyl alcohol stabilizers.

The Composition C may further comprise a defoamer and a biocide. The defoamer can be any effective defoamer. The biocide can be any effective preservative for high to neutral pH system.

The polyvinyl alcohol stabilized ethylene vinyl acetate emulsion polymer of Composition D has a typical Tg range from −10 to 20° C.

The PEI in Composition D can be replaced with other additives to impart water resistance, and one example is a zirconium compound, e.g., Bacote 20.

The Composition D may further comprise defoamer, plasticizer, biocide. The defoamer can be any effective defoamer. Suitable plasticizers include diethylene glycol dibenzoate, dipropylene glycol dibenzoate, propylene glycol dibenzoate, and preferably a dibenzoate ester of glycols. The biocide can be any effective preservative for low to neutral pH system.

The wet tack of the two-part adhesive, combined Composition C and Composition D, has a wet tack value greater than 130 g/inch force at 2 seconds, measured on Texture Analyzer.

In another embodiment, the two-part adhesive of Composition C and Composition D is applied onto substrates to from a laminate. The laminate is formed with a Substrate 1, a Substrate 2, Composition C on Substrate 1, and Composition D on Substrate 2; and the two compositions are brought together to undergo a reaction to gelatinize the adhesive. Substrate 1 and Substrate 2 are cellulose based- materials and are, independently, fiberboard, cardboard, kraft paper, fluted medium, linear medium, plastic film or foil. The Composition A and Composition B are the above described compositions.

To form the laminate with two-part adhesive of Compositions C and D:
a. composition C comprising polyethyleneimine in pH solution greater than about 9 is prepared;
b. composition D comprising boric acid and polyvinyl alcohol is prepared;
c. substate 1 having a first side and a second side is prepared;
d. substrate 2 having a first side and a second side is prepared;
e. composition C is applied on the first side of the Substrate 1;
f. composition D is applied on the second side of the Substrate 2; and
g. mating the Composition C on the first side of the Substrate 1 to the Composition D on the second side of Substrate 2.

The laminate may further comprise additional substrate, e.g., Substrate 3, 4, 5 and the like, and each may independently be selected from the group consisting of fiberboard, cardboard, kraft paper, fluted medium, linear medium, plastic film or foil. To adhere the additional substrates, Composition C and Composition D are applied on different substrates and joined together to gelatinize and adhere together.

The laminates may be formed at a higher temperature than ambient, room temperature. The Stein-Hall vessel temperatures are higher than the temperatures of the substrates. The temperatures recited herein are the temperatures of the substrates. The laminates may be formed at temperatures less than 250° F. In a preferred embodiment, the mating of Composition C and Composition D is conducted at temperature less than 190° F. In a more preferred embodiment, the mating is conducted at temperature less than 130° F. The laminates may also be made at room temperature without any additional heat. In some other embodiment, the laminates are made at room temperature, and additional heat or air circulation is used to drive off the excess water to hasten setting the adhesive.

The present invention may be better understood through analysis of the following examples, which are non-limiting and are intended only to help explain the invention.

### EXAMPLES

Example 1: Compositions A and B were prepared with the following contents in Table 1. Each component was added and mixed until homogeneous. Each composition totals to 100 parts.

TABLE 1

| | Parts (g) |
|---|---|
| Composition A | |
| Water | 88.75 |
| PVOH | 10.00 |
| PEI | 1.00 |
| Biocide, Defoamer | 0.25 |
| Composition B | |
| Water | 46.00 |
| Crosslinker | 0.20 |
| PVOH | 5.00 |
| EVA Emulsion Polymer, PVOH stabilized | 45.00 |
| Plasticizer | 3.50 |
| Biocide, Defoamer | 0.30 |

Laminates were formed with the above compositions. Composition A was applied onto a 42# liner board with a coating thickness of 1.5 mil and Composition B was applied onto a B-flute medium single face board by transfer coating from a 3-mil wet film. The coated flute was compressed onto the coated liner, and their wet tack was evaluated at 2 second, 5 second and 10 second separately.

It is well understood in the art that the wet tack of waterborne adhesive is not a single point property and it depends on the compression time, as well as adhesive coating weight. The debonding force measurement after the substrates are compressed together for a fixed time is reported. Direct measurement can be obtained on Texture Analyzer. A piece of SFC with a single 1-inch long flute can be mounted to the top probe, while the flat liner can be fixed to a bottom platform. Compression speed (2 mm/sec), force (100 grams), and duration (2, 5, 10 seconds), as well as the debonding speed (10 mm/sec), are programmed within the Texture Analyzer software. The peak force during the bond separation process is recorded and the average from multiple repeat test is taken as the wet tack value.

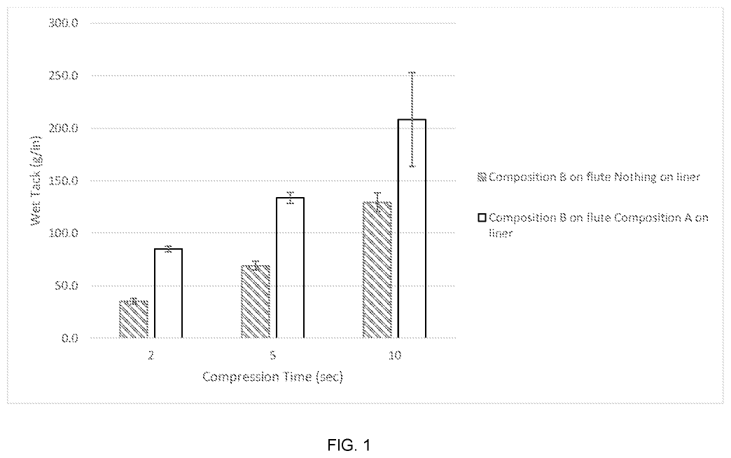

For comparative example, Composition B alone was applied onto a flute medium board and this was put together with a liner board. The wet tack of this laminate was also measured at 2 second, 5 second and 10 second interval. The average results are shown in Table 2. FIG. 1 also shows the average and its standard deviations of the wet tack of these laminates.

TABLE 2

| | Wet Tack for | Wet tack for Comparative |
|---|---|---|
| | Laminate 1 (g/in) | Laminate 2 (g/in) |
| seconds | Composition A + Composition B | Composition B |
| 2 | 85.1 ± 2.7 | 35.3 ± 2.8 |
| 5 | 133.8 ± 5.2 | 69.1 ± 4.2 |
| 10 | 208.3 ± 44.7 | 129.6 ± 8.9 |

Example 2: Compositions C and D were prepared with the following contents in Table 3. Each component was added and mixed until homogeneous. Each composition totals to 100 parts.

TABLE 3

| | Parts (g) |
|---|---|
| Composition C | |
| PVAc Emulsion Polymer, HEC Stabilized | 98.54 |
| Liquid Borax | 1.26 |
| Biocide, Defoamer | 0.20 |
| Composition D | |
| EVA Emulsion Polymer, PVOH stabilized | 93.80 |
| Plasticizer | 4.00 |
| Trigger | 2.00 |
| Biocide, Defoamer | 0.20 |

Two laminates were made for Table 3. Laminate 3 was made by applying Composition D onto a 42# liner board with a coating thickness of 1.5-mil and applying Composition C onto the flute of a single face board by transfer coating from a 3-mil wet film. Laminate 4 was made by applying Composition C onto a 42# liner board with a coating thickness of 1.5-mil and applying Composition D onto a flute of a single face board by transfer coating from a 3-mil wet film. Wet tack was measured for each laminate and their results are shown in Table 4.

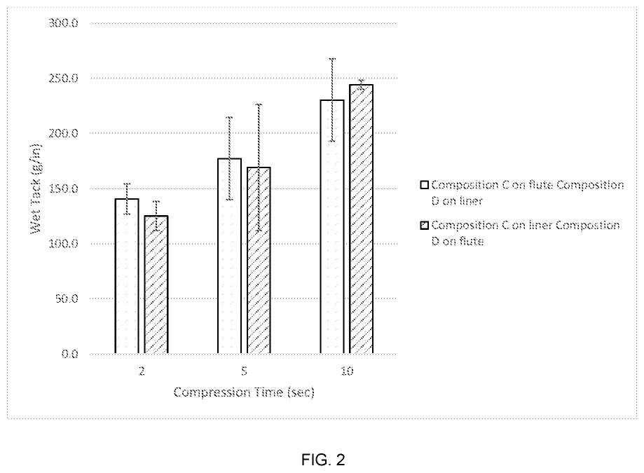

Differences were within the standard deviations, and this is also shown in FIG. 2.

TABLE 4

| | Wet Tack for | Wet Tack for |
|---|---|---|
| | Laminate 3 (g/in) | Laminate 4 (g/in) |
| | Composition C on | Composition D on |
| | flute medium | flute medium + |
| | Composition D on | Composition C on |
| Seconds | liner board + | liner board |
| 2 | 140.7 ± 13.6 | 125.3 ± 13.1 |
| 5 | 177.3 ± 37.4 | 169.2 ± 57.2 |
| 10 | 230.4 ± 37.4 | 244.2 ± 4.1 |

1. An adhesive comprising a reaction product of:
a. A composition A comprising polyethyleneimine in a polyvinyl alcohol solution having a pH value greater than about 9; and
b. A composition B comprising boric acid and polyvinyl alcohol stabilized ethylene-co-vinyl acetate emulsion polymer.

2. The adhesive of claim 1, wherein the composition A further comprises a biocide.

3. The adhesive of claim 1, wherein the composition B further comprises a plasticizer, defoamer, and biocide.

4. The adhesive of claim 1, wherein the wet tack of the reaction product is greater than 50 g/inch force at 2 seconds, measured by Texture Analyzer with 1 inch sample width, at compression speed of 2 mm/sec, compression force of 100 grams, and debonding speed of 10 mm/sec.

5. A laminate comprising:
a. a substrate 1;
b. a substrate 2;
c. an adhesive comprising the reaction product of composition A and composition B,
wherein the composition A comprises polyethyleneimine in a polyvinyl alcohol solution having a pH value greater than about 9; and
wherein the composition B comprises boric acid and polyvinyl alcohol stabilized ethylene-co-vinyl acetate emulsion polymer.

6. The laminate of claim 5,
wherein the substrate 1 is fiberboard, cardboard, kraft paper, fluted medium, linear medium, plastic film or foil; and
wherein the substrate 2 is fiberboard, cardboard, kraft paper, fluted medium or linear medium, plastic film or foil.

7. The laminate of claim 5,
wherein the composition A further comprises a biocide; and
wherein the composition B further comprises a plasticizer, defoamer, and biocide.

8. The laminate of claim 5 further comprising a substrate 3, selected from the group consisting of fiberboard, cardboard, kraft paper, fluted medium or linear medium, plastic film and foil.

9. A method for forming a laminate comprising:
a. Preparing a composition A comprising polyethyleneimine in a polyvinyl alcohol solution having a pH value greater than about 9;
b. Preparing a composition B comprising boric acid and polyvinyl alcohol stabilized ethylene-co-vinyl acetate emulsion polymer;
c. Preparing a substate 1 having a first side and a second side;
d. Preparing a substrate 2 having a first side and a second side;
e. Applying the composition A on the first side of the substrate 1;
f. Applying the composition B on the second side of the substrate 2;
g. Mating the composition A on the first side of the substrate 1 to the composition B on the second side of the substrate 2 onto each other.

10. The method of claim 9, wherein the mating is conducted at temperature of the substrate less than 250° F.

11. The method of claim 10, wherein the mating is conducted at temperature less than 130° F.

12. The method of claim 11,
wherein the substrate 1 is fiberboard, cardboard, kraft paper, fluted medium or linear medium, plastic film or foil; and
wherein the substrate 2 is fiberboard, cardboard, kraft paper, fluted medium or linear medium, plastic film or foil.

13. An adhesive comprising a reaction product of
a. A composition C comprising hydroxyethyl cellulose stabilized polyvinyl acetate emulsion polymer and aminoborate compound; and
b. A composition D comprising polyvinyl alcohol stabilized ethylene vinyl acetate emulsion polymer and polyethyleneimine.

14. The adhesive of claim 13, wherein the composition C further comprises a defoamer and a biocide.

15. The adhesive of claim 13, wherein the composition D further comprises a defoamer, plasticizer, biocide.

16. The adhesive of claim 13, wherein the wet tack of the reaction product is greater than 50 g/inch force at 2 seconds, measure by Texture Analyzer, with 1 inch sample width, at compression speed of speed of 2 mm/sec, compression force of 100 grams, and debonding speed of 10 mm/sec.

17. A laminate comprising:
a. a substrate 1;
b. a substrate 2;
c. an adhesive comprising the reaction product of composition C and composition D,
Wherein the adhesive C comprises polyvinyl acetate emulsion polymer and aminoborate compound; and
Wherein the adhesive D comprises polyvinyl alcohol stabilized ethylene vinyl acetate emulsion polymer and polyethyleneimine.

18. The laminate of claim 17,
wherein the substrate 1 is fiberboard, cardboard, kraft paper, fluted medium, linear medium, plastic film or foil; and
wherein the substrate 2 is fiberboard, cardboard, kraft paper, fluted medium or linear medium, plastic film or foil.

19. The laminate of claim 17,
wherein the adhesive C further comprises a defoamer and a biocide; and
wherein the adhesive D further comprises defoamer, plasticizer, biocide.

20. The laminate of claim 17 further comprising a substrate 3, selected from the group consisting of fiberboard, cardboard, kraft paper, fluted medium or linear medium, plastic film and foil.

21. A method for forming a laminate comprising
a. preparing a composition C comprising polyvinyl acetate emulsion polymer and aminoborate compound;
b. preparing a composition D comprising polyvinyl alcohol stabilized ethylene vinyl acetate emulsion polymer and polyethyleneimine;
c. preparing a substate 1 having a first side and a second side;
d. preparing a substrate 2 having a first side and a second side;
e. applying the adhesive C on the first side of the substrate 1;
f. applying the adhesive D on the second side of the substrate 2; and
g. mating the adhesive C on the first side of the substrate 1 to the adhesive D on the second side of the substrate 2 onto each other.

22. The method of claim 21, wherein the mating is conducted at temperature less than 250° F.

23. The method of claim 22, wherein the mating is conducted at temperature less than 130° F.

24. The method of claim 21,
wherein the composition C further comprises a defoamer and a biocide; and
wherein the composition D further comprises defoamer, plasticizer, biocide.

25. The method of claim 21, wherein the substrate 1 is fiberboard, cardboard, kraft paper, fluted medium or linear medium, plastic film or foil; and
wherein the substrate 2 is fiberboard, cardboard, kraft paper, fluted medium or linear medium, plastic film or foil.
